(19) United States
(12) Patent Application Publication
(10) Pub. No.: US 2023/0124354 A1
(43) Pub. Date: Apr. 20, 2023

(54) SUPPORT APPARATUS, SUPPORT METHOD AND PROGRAM

(71) Applicant: NIPPON TELEGRAPH AND TELEPHONE CORPORATION, Tokyo (JP)

(72) Inventors: Wataru AKAHORI, Tokyo (JP); Ai NAKANE, Tokyo (JP); Momoko NAKATANI, Tokyo (JP)

(73) Assignee: NIPPON TELEGRAPH AND TELEPHONE CORPORATION, Tokyo (JP)

(21) Appl. No.: 17/910,803

(22) PCT Filed: Dec. 14, 2020
(86) PCT No.: PCT/JP2020/046603

§ 371 Date: Sep. 10, 2022

(30) Foreign Application Priority Data
Mar. 13, 2020 (JP) PCT/JP2020/011194

(51) Int. Cl. G06F 40/30; G06F 40/253

(52) U.S. Cl. CPC G06F 40/30; G06F 40/253

(57) ABSTRACT

An assistance apparatus according to an embodiment includes: a concreteness calculation unit for calculating, by using a plurality of predetermined words included in an input sentence and an answer expression describing an answer to at least one 5W1H sentence in the input sentence, concreteness indicating a degree to which the input sentence is concretely written; and a notification sentence creation unit for creating a notification sentence for encouraging a user to write a concrete sentence in a case in which the concreteness is lower than a predetermined threshold.

### TECHNICAL FIELD

The present disclosure relates to an assistance apparatus, an assistance method, and a program.

### BACKGROUND ART

When a writer writes a sentence, it is difficult for the writer to judge whether the sentence can be described concretely. Various inconveniences may thus happen as a result of a non-concrete sentence. In a case in which a goal for a physical activity is set, and if the goal is not concretely written, for example, inconveniences such as difficulty in continuously carrying out physical activity to achieve the goal occur.

In the related art, there is known a technique for assisting verbalization of an information request that a user wants to know when creating a query to be input to a search engine (NPL 1).

### CITATION LIST

### Non Patent Literature

NPL 1: Atsushi Otsuka, Yohei Seki, Noriko Kando, Tetsuji Satoh, “QAque: Faceted Query Expansion Techniques for Exploratory Search using Community QA Resources”, WWW '12 Companion: Proceedings of the 21st International Conference on World Wide Web, April 2012, Pages 799 to 806

### SUMMARY OF THE INVENTION

### Technical Problem

However, while the aforementioned related art can assist the verbalization of an information request, whether a concrete sentence is obtained as a result of the verbalization is not taken into consideration.

An embodiment of the present disclosure was made in view of the aforementioned circumstances, and an object thereof is to assist writing of a concrete sentence.

### Means for Solving the Problem

In order to achieve the aforementioned object, an assistance apparatus according to an embodiment includes: a concreteness calculation unit for calculating, by using a plurality of predetermined words included in an input sentence and an answer expression describing an answer to at least one 5W1H sentence in the input sentence, concreteness indicating a degree to which the sentence is concretely written; and a notification sentence creation unit for creating a notification sentence for encouraging a user to write a concrete sentence in a case in which the concreteness is lower than a predetermined threshold.

### Effects of the Invention

It is possible to assist writing of a concrete sentence.

### BRIEF DESCRIPTION OF DRAWINGS

FIG. 1 is a diagram illustrating an example of an overall configuration of a concrete sentence expression assistance apparatus according to a first embodiment.

FIG. 2 is a table illustrating an example of a keyword concreteness data base (DB) according to the first embodiment.

FIG. 3 is a table illustrating an example of a sentence example DB according to the first embodiment.

FIG. 4 is a flowchart illustrating an example of concrete sentence expression assistance processing according to the first embodiment.

FIG. 5 is a diagram illustrating an example of a hardware configuration of the concrete sentence expression assistance apparatus according to the first embodiment.

FIG. 6 is a diagram illustrating an example of an overall configuration of a concrete sentence expression assistance apparatus according to a second embodiment.

FIG. 7 is a table illustrating an example of a sentence example DB according to the second embodiment.

FIG. 8 is a flowchart illustrating an example of a concrete sentence expression assistance processing according to the second embodiment.

### DESCRIPTION OF EMBODIMENTS

Hereinafter, an embodiment of the present disclosure will be described.

### First Embodiment

The present embodiment will describe a concrete sentence expression assistance apparatus 10 capable of assisting writing of a concrete sentence by encouraging a user to write a concrete sentence in a case in which a given sentence is not concrete. In the following description, it is assumed that a sentence indicating a goal setting related to a physical activity is given to the concrete sentence expression assistance apparatus 10 as an example. Examples of the sentence indicating a goal setting related to the physical activity include “I strengthen the muscular power of my upper body”.

However, the present embodiment is not limited to such a sentence that indicates a goal setting related to a physical activity and can be similarly applied to a case in which any sentence is given to the concrete sentence expression assistance apparatus 10.

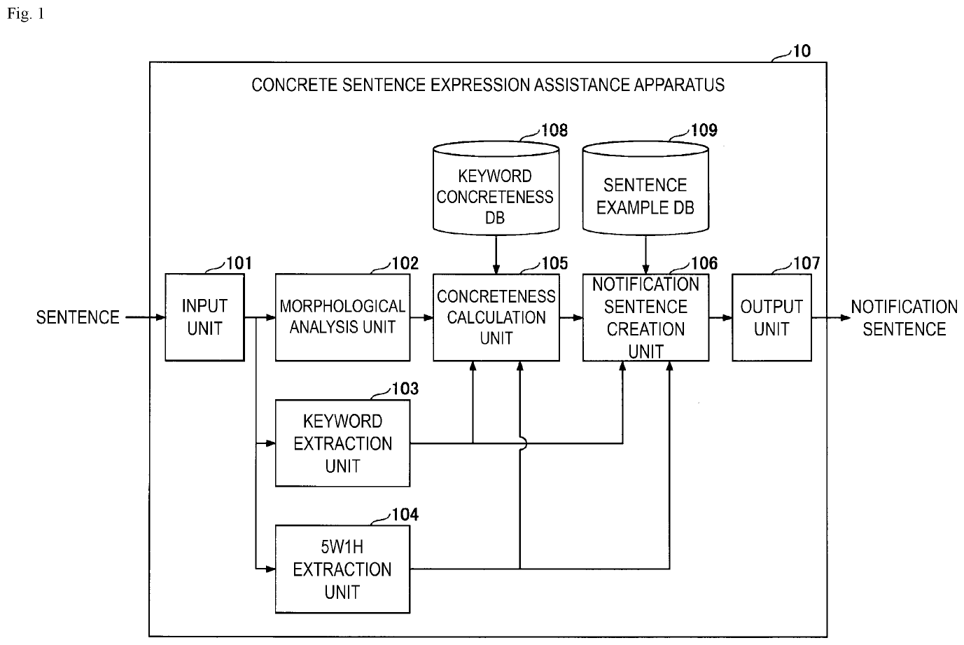

Overall Configuration First, an overall configuration of the concrete sentence expression assistance apparatus 10 according to the present embodiment will be described with reference to FIG. 1. FIG. 1 is a diagram illustrating an example of the overall configuration of the concrete sentence expression assistance apparatus 10 according to the present embodiment.

As illustrated in FIG. 1, the concrete sentence expression assistance apparatus 10 according to the present embodiment includes an input unit 101, a morphological analysis unit 102, a keyword extraction unit 103, a 5W1H extraction unit 104, a concreteness calculation unit 105, a notification sentence creation unit 106, an output unit 107, a keyword concreteness DB 108, and a sentence example DB 109.

The input unit 101 inputs a sentence (text) provided to the concrete sentence expression assistance apparatus 10. Note that the input unit 101 may input a sentence input by a user with a keyboard or a touch panel, may input a sentence stored in such as an auxiliary storage device, or may input a sentence received from another device (a server or a terminal, for example) connected via a communication network, for example.

The morphological analysis unit 102 calculates the number of morphemes by performing morphological analysis on the sentence input through the input unit 101. The morphological analysis unit 102 performs morphological analysis on a sentence by an arbitrary method, by using, for example, a scheme or a morphological analysis system described in Reference Document 1 “Yuji Matsumoto, Akira Kitauchi, Tatsuo Yamashita, Yoshitaka Hirano, Hiroshi Matsuda, Kazuma Takaoka, Masayuki Asahara, “Morphological Analysis System ‘ChaSen’”, Information Processing, 41(11), 1208-1214 (2000).”

The keyword extraction unit 103 extracts keywords from the sentence input by the input unit 101. Here, the keyword is a word determined in advance and is determined in response to contents, a purpose, and the like of a sentence that encourage a user to write concretely. For a sentence indicating a goal setting related to a physical activity, for example, words related to the physical activity, activities or concepts related to the physical activity, and the like, such as “physical”, “muscular power”, “upper body”, “squat”, “biceps brachii”, “muscular power”, “injury”, “calorie”, “meal”, and “partner” are determined as keywords. Note that the keyword extraction unit 103 is required to extract a keyword from a sentence by an arbitrary method, for example, by using a scheme described in Reference Document 2 “Masahiko Matsushita, Hiromitsu Nishizaki, Takehito Utsuro, Seiichi Nakagawa, “Improvement of Keyword Recognition and Extraction for Speech-driven Web Retrieval Task”, Information Processing Society of Japan, Research Report, Spoken Language Processing (SLP), 2003 (104 (2003-SLP-048)), 21 to 28”.

The 5W1H extraction unit 104 extracts 5W1H information from the sentence input through the input unit 101. Here the 5W1H information is a set of words (or a phrase) that is an answer to any of 5W1H elements and a label indicating for which 5W1H elements the word (or the phrase) answers. Note that the elements of 5W1H sentences mean “Why”, “What”, “Who”, “Where”, “When”, and “How”. Hereinafter, labels representing these elements will be represented as a “Why label”, a “What label”, a “Who label”, a “Where label”, a “When label”, and a “How label”.

Specifically, in a case in which a sentence “I strengthen muscular power of my upper body.” is input by the input unit 101, for example, the phrase “I will” is a phrase as an answer to “Who”, and the phrase “muscular power of my upper body” is a phrase as an answer to “What”. Thus, in the case in which the sentence “I strengthen muscular power of my upper body.” is input by the input unit 101, for example, a set of “I will” and a Who label and a set of “muscular power of my upper body” and a What label are extracted as 5W1H information. The 5W1H extraction unit 104 is required to extract the 5W1H information from sentences by an arbitrary method, for example, by using a scheme described in Reference Document 3 “Akitoshi Okumura, Tadahiro Ikeda, Kazutoshi Muraki, “Text Summarization based on Information Extraction and Categorization Using 5W1H”, Natural Language Processing, 6(6), 27 to 44 (1999)”, for example.

The concreteness calculation unit 105 calculates concreteness indicating a degree to which a sentence is concretely written, by using the number of morphemes calculated by the morphological analysis unit 102, the keywords extracted by the keyword extraction unit 103, and the 5W1H information extracted by the 5W1H extraction unit 104. Specifically, the number of morphemes calculated by the morphological analysis unit 102 is defined as N, the number of keywords extracted by the keyword extraction unit 103 is defined as M, the keywords are defined as km (where m=1, M), the keyword concreteness of the keywords km is defined as Km, the number of pieces of the 5W1H information extracted by the 5W1H extraction unit 104 (that is, the number of elements of 5W1H sentences for which answer words or phrases are written in the sentence) is defined as L. At this time, the concreteness calculation unit 105 calculates the concreteness C by C=N+(K1++KM)+L. Here, the keyword concreteness is a value set in advance for each keyword and is stored in the keyword concreteness DB 108. Thus, the concreteness calculation unit 105 refers to the keyword concreteness DB 108 and acquires keyword concreteness Km corresponding to the keyword km when the concreteness calculation unit 105 calculates the concreteness C. Note that details of the keyword concreteness DB 108 will be described below.

The notification sentence creation unit 106 creates a notification sentence (hereinafter, referred to as an “output notification sentence”) that is an output target of the output unit 107 in accordance with the concreteness C calculated by the concreteness calculation unit 105. Specifically, in a case in which the concreteness C is equal to or greater than a predetermined threshold (that is, in a case in which the input sentence is concrete), the notification sentence creation unit 106 creates, as an output notification sentence, a notification sentence (a notification sentence such as “Your writing seems to be concrete.”, for example) indicating that writing of the sentence is concrete. On the other hand, in a case in which the concreteness C is less than the predetermined threshold (that is, in a case in which the input sentence is not concrete), the notification sentence creation unit 106 creates, as an output notification sentence, a sentence in which a first notification sentence indicating that the sentence is not concretely written, a second notification sentence in accordance with elements of 5W1H sentences for which answer words or phrases are not written in the sentence, and a third notification sentence created from a sentence example stored in the sentence example DB 109 are connected together. Here, the sentence example is a sentence created in advance in accordance with a keyword and is stored in the sentence example DB 109. Thus, the notification sentence creation unit 106 selects, from the sentence example DB 109, a sentence example corresponding to the keywords extracted by the keyword extraction unit 103 and creates the third notification sentence from the selected sentence example. Note that details of the sentence example DB 109 will be described below.

The output unit 107 outputs the output notification sentence created by the notification sentence creation unit 106. Note that the output unit 107 may output (display) the output notification sentence to a display device such as a display, may output an output notification sentence as sound from a speaker or the like, or may output (transmit) the output notification sentence to another device (a server or a terminal, for example) connected via a communication network, for example.

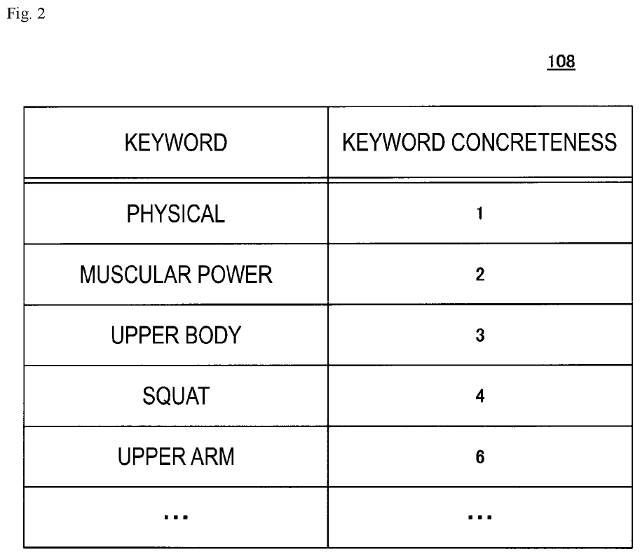

The keyword concreteness DB 108 is a database in which keywords and keyword concreteness of the keywords are stored in an associated manner. An example of the keyword concreteness DB 108 according to the present embodiment is indicated in FIG. 2. FIG. 2 is a table illustrating an example of the keyword concreteness DB 108 according to the present embodiment.

In the keyword concreteness DB 108 illustrated in FIG. 2, a keyword “physical” and keyword concreteness “1” are stored in an associated manner. Similarly, in the keyword concreteness DB 108 illustrated in FIG. 2, keyword concreteness “muscular power” and keyword concreteness “2”, a keyword “upper body” and keyword concreteness “3”, a keyword “squat” and keyword concreteness “4”, and a keyword “upper arm” and keyword concreteness “6” are stored in an associated manner. In this manner, data in which keywords determined in advance and keyword concreteness of the keywords are associated is stored in the keyword concreteness DB 108.

Here, the keyword concreteness is set in advance for each keyword, and for example, the keyword concreteness is set to be high when the meaning of a keyword is concrete and is set to be low when the meaning of the keyword is abstract. Thus, each piece of data stored in the keyword concreteness DB 108 may form a tree structure in which the lower the keyword concreteness, the closer to the root, and the higher the keyword concreteness, the closer to the leaf, based on the semantic inclusion and semantic similarity of keywords, for example.

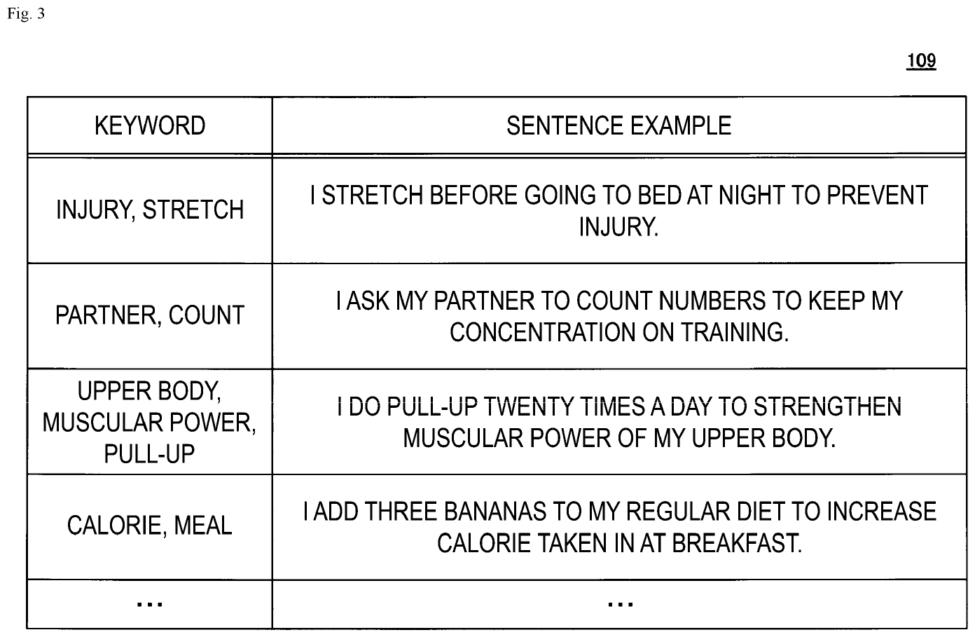

The sentence example DB 109 is a database in which one or a plurality of keywords and sentence examples corresponding to the one or plurality of keywords are stored in an associated manner. An example of the sentence example DB 109 according to the present embodiment will be illustrated in FIG. 3. FIG. 3 is a table illustrating an example of the sentence example DB 109 according to the present embodiment.

In the sentence example DB 109 illustrated in FIG. 3, a keywords “injury” and “stretch” and a sentence example “I stretch before going to bed at night to prevent injury.” are stored in an associated manner. Similarly, in the sentence example DB 109 illustrated in FIG. 3, keywords “partner” and “count” and a sentence example “I ask my partner to count numbers to keep my concentration on training.” are stored in an associated manner. The same applies to the following description, keywords “upper body”, “muscular power”, and “pull-up” and a sentence example “I do pull-up twenty times a day to strengthen the muscular power of my upper body.” are stored in an associated manner, and keywords “calorie” and “diet” and a sentence example “I add three bananas to my regular diet to increase the calorie taken in at breakfast.” are stored in an associated manner. In this manner, data in which one or a plurality of keywords determined in advance and a sentence example including one or a plurality of keywords are associated is stored in the sentence example DB 109. However, the sentence example includes not only the one or plurality of keywords but is a concrete sentence (at least a concrete sentence to some extent) that can be a reference when the user writes a concrete sentence.

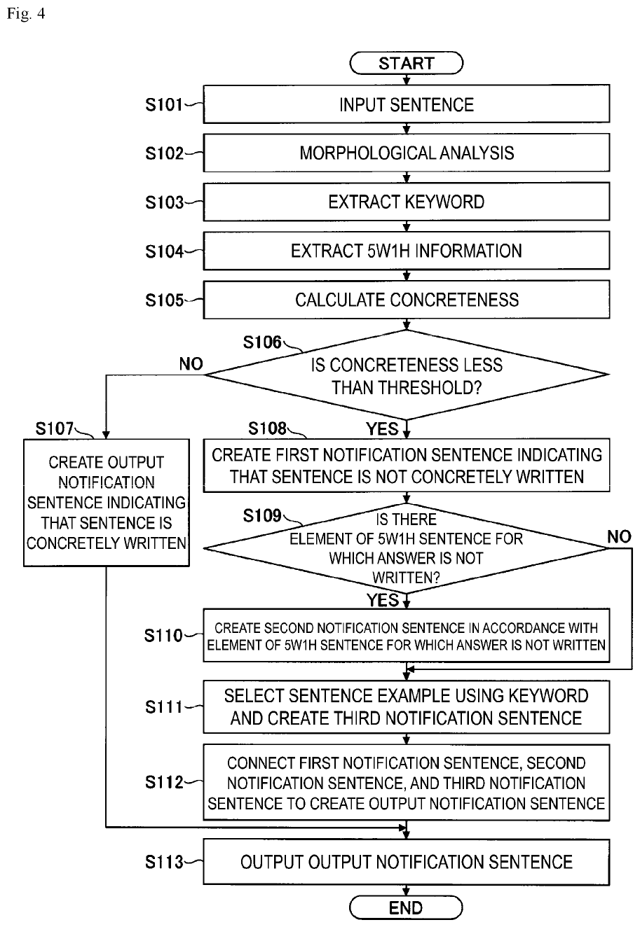

Concrete Sentence Expression Assistance Processing Next, processing of encouraging a user to write a concrete sentence and assisting writing of a concrete sentence in a case in which the sentence written by the user is not concrete will be described with reference to FIG. 4. FIG. 4 is a flowchart illustrating an example of the concrete sentence expression assistance processing according to the present embodiment.

First, the input unit 101 inputs a given sentence (Step S101).

Next, the morphological analysis unit 102 performs morphological analysis on the sentence input in Step S101 above to calculate the number of morphemes (Step S102). Hereinafter, the number of morphemes calculated in this step is defined as N.

Next, the keyword extraction unit 103 extracts keywords from the sentence input in Step S101 above (Step S103). Hereinafter, the number of keywords extracted in this step is defined as M, and each keyword is defined as kl, . . . , kM.

Next, the 5W1H extraction unit 104 extracts 5W1H information from the sentence input in Step S101 above (Step S104). Hereinafter, the number of pieces of 5W1H information extracted in this step is defined as L.

Note that the processing in Steps S102 to S104 above is executed in any selected order.

Next, the concreteness calculation unit 105 acquires keyword concreteness Km corresponding to the keywords km (where m=1, . . . , M) from the keyword concreteness DB 108 and calculates the concreteness C by C=N+(K1+ . . . +KM)+L (Step S105).

For example, it is assumed that the sentence input in Step S101 above is “I strengthen muscular power of my upper body.”. In this case, the number of morphemes calculated by the morphological analysis unit 102 is N=8. If keywords “upper body” and “muscular power” are extracted by the keyword extraction unit 103, the keyword concreteness of “upper body” is “3”, and the keyword concreteness of “muscular power” is “2”. Moreover, 5W1H information extracted by the 5W1H extraction unit 104 is (“I”; Who label) and (“muscular power of my upper body”; What label), and thus L=2. Thus, the concreteness C in this case is C=8+2+3+2=15.

Note that the method of calculating the concreteness C is not limited thereto, and the concreteness C may be calculated by C=(K1+ . . . +KM)+L (that is, the number of morphemes N may not be used), for example. In this case, the processing in Step S102 above may not be executed (thus, the concrete sentence expression assistance apparatus 10 may not include the morphological analysis unit 102).

Next, the notification sentence creation unit 106 determines whether the concreteness C calculated in Step S105 above is less than a predetermined threshold (Step S106).

In a case in which the concreteness C is determined not to be less than the predetermined threshold in Step S106 above (that is, in a case in which the sentence input in Step S101 above is concrete), the notification sentence creation unit 106 creates, as an output notification sentence, a notification sentence indicating that the writing of the sentence is concrete (for example, a notification sentence such as “Your writing seems to be concrete.”) (Step S107). In this manner, the user can ascertain that the sentence that the user himself/herself has written is concrete.

On the other hand, in a case in which the concreteness C is determined to be less than the predetermined threshold in Step S106 above (that is, in a case in which the sentence input in Step S101 above is not concrete), the notification sentence creation unit 106 creates a first notification sentence indicating that the sentence is not concretely written (for example, a notification sentence such as “Your writing seems not to be concrete. Please write a more concrete sentence.”) (Step S108).

Next, the notification sentence creation unit 106 determines whether there are elements of 5W1H sentences for which answer words or phrases are not written in the sentence, using the 5W1H information extracted in Step S104 above (Step S109). In other words, the notification sentence creation unit 106 determines whether there are labels that are not included in the 5W1H information extracted in Step S104 above from among the “Why label”, the “What label”, the “Who label”, the “Where label”, the “When label”, and the “How label”.

In a case in which it is determined that there are elements of 5W1H sentences for which words or phrases answer are not written in the sentence in Step S109 above, the notification sentence creation unit 106 creates a second notification sentence in accordance with the elements of 5W1H for which answer words or phrases are not written (Step S110).

When the elements of 5W1H sentences for which answer words or phrases are not written are “why” and “how”, for example, the notification sentence creation unit 106 creates a sentence such as “Please think about why and how.” as the second notification sentence. Similarly, when the elements of 5W1H sentences for which answer words or phrases are not written are “Why”, “Where”, “When”, and “How”, for example, the notification sentence creation unit 106 creates a sentence such as “Please think about why, where, when, and how.” as a second notification sentence.

It is only necessary for such a second notification sentence to be created by preparing a sentence such as “Please think about *”, for example, in advance and replacing “*” with a combination of expressions (“why”, “what”, “who”, “where”, “when”, and “how”) corresponding to the elements of 5W1H sentences for which answer words or phrases are not written, in accordance with the elements.

When it is determined that there are no elements of 5W1H sentences for which answer words or phrases are not written in the sentence in Step S109 above, or after Step S110 above, the notification sentence creation unit 106 selects a sentence example corresponding to the keywords extracted in Step S103 above from the sentence example DB 109 and creates a third notification sentence from the selected sentence example (Step S111). Note that when the sentence example is selected from the sentence example DB 109, the notification sentence creation unit 106 may select all sentence examples corresponding to the keywords extracted in Step S103 above from the sentence example DB 109 or may select a sentence example with the highest degree of matching with the keywords extracted in Step S103 above (or a predetermined number of sentence examples in a descending order from the highest degree of matching) from the sentence example DB 109. In a case in which sentence examples are selected from the sentence example DB 109 illustrated in FIG. 3, and the keywords extracted in Step S103 above are “upper body”, “muscular power”, and “calorie”, for example, the following two sentence examples are selected. The first one is a sentence example “I do pull-up twenty times a day to strengthen the muscular power of my upper body.” corresponding to the keywords “upper body” and “muscular power”. The second one is a sentence example “I add three bananas to my regular diet to increase the calorie taken in at breakfast.” corresponding to the keyword “calorie”. Alternatively, only a sentence example “I do pull-up twenty times a day to strengthen the muscular power of my upper body.” with the highest degree of matching with the keywords “upper body”, “muscular power”, and “calorie” is selected. Here, the degree of matching between the keywords extracted by the keyword extraction unit 103 and the sentence example is the number of keywords extracted by the keyword extraction unit 103 in one or a plurality of keywords corresponding to the sentence example.

When the third notification sentence is created, for example, the notification sentence creation unit 106 creates a sentence such as “Please refer to “I do pull-up twenty times a day to strengthen the muscular power of my upper body.”, for example.” as the third notification sentence using the sentence example “I do pull-up twenty times a day to strengthen the muscular power of my upper body.” selected from the sentence example DB 109.

Such a third notification sentence is created by preparing a sentence such as “Please refer to *, for example.”, for example, in advance, adding brackets to the sentence example selected from the sentence example DB 109, and replacing “*” with the selected sentence example.

Next, the notification sentence creation unit 106 creates a sentence connecting the first notification sentence, the second notification sentence, and the third notification sentence as an output notification sentence (Step S112). However, in a case in which the processing in Step S110 above is not implemented (that is, when it is determined in step S109 above that there is no 5W1H element for which answer words or phrases are not written in the sentence), the notification sentence creation unit 106 creates a sentence connecting the first notification sentence and the third notification sentence as an output notification sentence.

For example, it is assumed that the first notification sentence is “Your writing seems not to be concrete. Please write a more concrete sentence.”, the second notification sentence is “Please think about why, where, when, and how.”, and the third notification sentence is “Please refer to “I do pull-up twenty times a day to strengthen the muscular power of my upper body.”, for example.”. In this case, the notification sentence creation unit 106 creates, as an output notification sentence, a sentence connecting these notification sentences “Your writing seems not to be concrete. Please write a more concrete sentence. Please think about why, where, when, and how. Please refer to “I do pull-up twenty times a day to strengthen the muscular power of my upper body.”, for example.”.

After Step S107 above or Step S112 above, the output unit 107 outputs the output notification sentence created by the notification sentence creation unit 106 (Step S113). In this manner, the output notification sentence is presented to the user. Thus, in a case in which the output notification sentence is created in Step S112 above, for example, the user can ascertain that the sentence written by the user is not concrete and can obtain information (the second notification sentence and the third notification sentence) that can be referred to for writing a concrete sentence.

As described above, the concrete sentence expression assistance apparatus 10 according to the present embodiment encourages the user to write a concrete sentence and presents information that can be referred to for writing a concrete sentence in a case in which an input sentence is not concrete. It is thus possible to assist writing of a concrete sentence in a case in which the sentence written by the user is not concrete, for example.

Note that although only keywords are used when the sentence example is selected from the sentence example DB 109 in Step S111 above in the present embodiment, the present disclosure is not limited thereto, and 5W1H information, for example, may be used in addition to the keywords. For example, a sentence example corresponding to the keywords extracted by the keyword extraction unit 103 and including answer words or phrases of elements of 5W1H sentences for which answer words or phrases are not written in the input sentence (or at least one of such elements) included therein, may be selected from the sentence example DB 109. It is thus possible for the user to refer to the sentence example including the answers of the elements of 5W1H sentences, which are not written in the sentence written by the user.

Although the output notification sentence is created in Step S107 in FIG. 4 above, the present disclosure is not limited thereto, and the processing in Steps S109 to Step 113 may be executed after the notification sentence indicating that the writing of the sentence is concrete is created, for example. It is thus possible to encourage the user to write a concrete sentence in a case in which writing that is the answer of elements of 5W1H sentences is omitted although the input sentence is concrete to some extent (that is, the concreteness C is equal to or greater than the predetermined threshold).

In addition, although the output notification sentence is output in Step S113 in FIG. 4 above, the present disclosure is not limited thereto, and each notification sentence may be output at a timing at which each of the first notification sentence, the second notification sentence, and the third notification sentence is created, for example. In other words, each notification sentence may be output at the timing when the first notification sentence is created in Step S108, the timing when the second notification sentence is created in Step S110, and the timing when the third notification sentence is created in Step S111. In this case, the processing in Step S112 and Step S113 above is not necessary.

Although whether the concreteness C is less than the predetermined threshold is determined in Step S106 in FIG. 4 above, the threshold may be set for each element (that is, three elements, namely N, a sum of K1 to KM, and L) constituting the concreteness C, and whether a predetermined number (where the number is from one and to three) of elements among these elements are less than the threshold may be determined, for example. In this case, Step S108 is executed when more than the predetermined number of elements are determined to be less than the threshold, or Step S107 is executed otherwise.

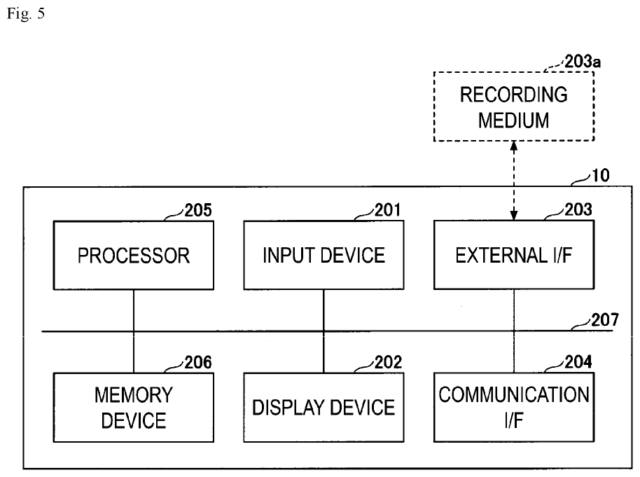

Hardware Configuration Next, a hardware configuration of the concrete sentence expression assistance apparatus 10 according to the present embodiment will be described with reference to FIG. 5. FIG. 5 is a diagram illustrating an example of the hardware configuration of the concrete sentence expression assistance apparatus 10 according to the present embodiment.

As illustrated in FIG. 5, the concrete sentence expression assistance apparatus 10 according to the present embodiment is realized by a general computer or a computer system and includes an input device 201, a display device 202, an external I/F 203, a communication I/F 204, a processor 205, and a memory device 206. The hardware is communicably connected to each other via a bus 207.

The input device 201 is, for example, a keyboard, a mouse, or a touch panel. The display device 202 is, for example, a display or the like. Note that the concrete sentence expression assistance apparatus 10 may not include at least either the input device 201 or the display device 202.

The external I/F 203 is an interface for an external device. Examples of the external device include a recording medium 203a and the like. The concrete sentence expression assistance apparatus 10 can perform reading, writing, and the like of the recording medium 203a via the external I/F 203. The recording medium 203a may store one or a plurality of programs for realizing each functional unit (the input unit 101, the morphological analysis unit 102, the keyword extraction unit 103, the 5W1H extraction unit 104, the concreteness calculation unit 105, the notification sentence creation unit 106, and the output unit 107) included in the concrete sentence expression assistance apparatus 10. Examples of the recording medium 203a include a compact disc (CD), a digital versatile disk (DVD), a secure digital memory card (SD memory card), and a universal serial bus (USB) memory card.

The communication I/F 204 is an interface to connect the concrete sentence expression assistance apparatus 10 to the communication network. Note that the one or plurality of programs realizing each functional unit included in the concrete sentence expression assistance apparatus 10 may be acquired (downloaded) from a predetermined server device or the like via the communication I/F 204.

The processor 205 is any of various calculation devices such as a central processing unit (CPU) or a graphics processing unit (GPU). Each functional unit included in the concrete sentence expression assistance apparatus 10 is realized by processing that the one or plurality of programs stored in the memory device 206 cause the processor 205 to execute, for example.

The memory device 206 is any of various storage devices such as a hard disk drive (HDD), a solid state drive (SSD), a random access memory (RAM), a read only memory (ROM), and a flash memory. Each DB (the keyword concreteness DB 108 and the sentence example DB 109) included in the concrete sentence expression assistance apparatus 10 is implemented by the memory device 206, for example. However, at least one of these DBs may be realized by a storage device (for example, a database server) connected to the concrete sentence expression assistance apparatus 10 via a communication network.

The concrete sentence expression assistance apparatus 10 according to the present embodiment can realize the concrete sentence expression assistance processing described above by including the hardware configuration illustrated in FIG. 5. Note that the hardware configuration illustrated in FIG. 5 is an example, and the concrete sentence expression assistance apparatus 10 may have another hardware configuration. For example, the concrete sentence expression assistance apparatus 10 may include a plurality of processors 205 or may include a plurality of memory devices 206.

### Second Embodiment

In the first embodiment, it is possible to assist concrete expression in a case in which a sentence is not concrete, while only presence/absence of elements of 5W1H sentences for which answer words or phrases are not written is taken into consideration. On the other hand, it would be possible to assist writing a further concrete sentence by considering which 5W1H element is treated with priority and how much priority is given to the 5W1H element, instead of the presence/absence of the 5W1H element.

Thus, a case will be described in the present embodiment in which writing of a more concrete sentence is assisted by considering a weight of each 5W1H element and which 5W1H element should be expressed concretely.

Note that differences from the first embodiment will be mainly described, and description of components similar to those in the first embodiment will be omitted in the second embodiment.

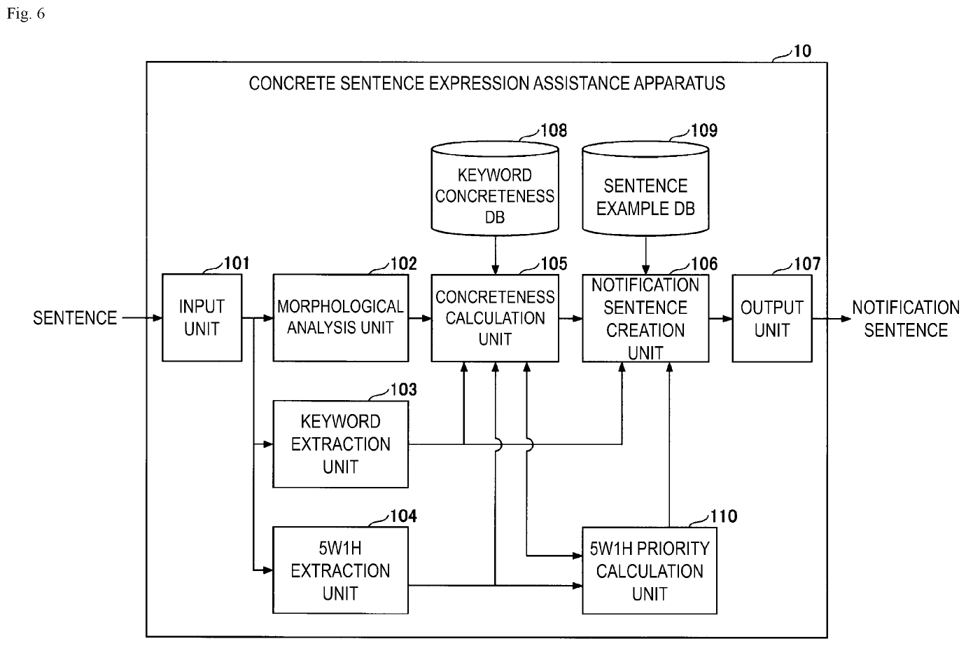

Overall Configuration First, an overall configuration of the concrete sentence expression assistance apparatus 10 according to the present embodiment will be described with reference to FIG. 6. FIG. 6 is a diagram illustrating an example of the overall configuration of the concrete sentence expression assistance apparatus according to the present embodiment.

As illustrated in FIG. 6, the concrete sentence expression assistance apparatus 10 according to the present embodiment includes a 5W1H priority calculation unit 110 in addition to each component described in the first embodiment. Also, in the present embodiment, functions included in the concreteness calculation unit 105 and the notification sentence creation unit 106 are different from those in the first embodiment, and data stored in the sentence example DB 109 is different from that in the first embodiment.

The concreteness calculation unit 105 calculates concreteness C using a weight of each 5W1H element in addition to the number of morphemes, keywords, and 5W1H information. Here, the weight of each 5W1h element is a value that is from 0 to 1 and is set in advance. Here, which element of a plurality of 5W1H elements is weighted (or reduced weighting) can differ depending on the domain of a sentence desired to assist concrete expression. For example, it is considered to be necessary to set weights of “When” and “Where” to be relatively large in a sentence of a domain related to a plan, a schedule, or the like. On the other hand, it is considered to be necessary to set weights of “What” and “How” to be relatively large in a sentence of a domain related to a food material cooking method, for example. Hereinafter, the weights of “Why”, “What”, “Who”, “Where”, “When”, and “How” will be represented as aWhy, aWhat, aWho, aWhere, aWhen, and aHow, respectively. Note that a method of calculating the concreteness C according to the present embodiment will be described below.

Also, the concreteness calculation unit 105 calculates concreteness of each 5W1H element in a given sentence using 5W1H information. Hereinafter, concreteness of “Why”, “What”, “Who”, “Where”, “When”, and “How” will be represented as CWhy, CWhat, CWho, CWhere, CWhen, and CHow, respectively. Note that a method of calculating the concreteness CWhy, CWhat, CWho, CWhere, CWhen, and CHow will be described below.

The 5W1H priority calculation unit 110 calculates priority of each element of 5W1H sentences using the concreteness CWhy, CWhat, CWho, CWhere, CWhen, and CHow calculated by the concreteness calculation unit 105 and the weight aWhy, aWhat, aWho, aWhere, aWhen, and aHow of each 5W1H element. Hereinafter, priority of “Why”, “What”, “Who”, “Where”, “When”, and “How” will be represented as PWhy, PWhat, PWho, PWhere, PWhen, and PHow, respectively. Note that a method of calculating the priority PWhy, PWhat, PWho, PWhere, PWhen, and PHow will be described below.

The notification sentence creation unit 106 creates a sentence in consideration of the priority PWhy, PWhat, PWho, PWhere, PWhen, and PHow of the 5W1H elements when the second notification sentence is created. Also, the notification sentence creation unit 106 also creates a sentence in consideration of the priority PWhy, PWhat, PWho, PWhere, PWhen, and PHow of the 5W1H elements when the third notification sentence is created.

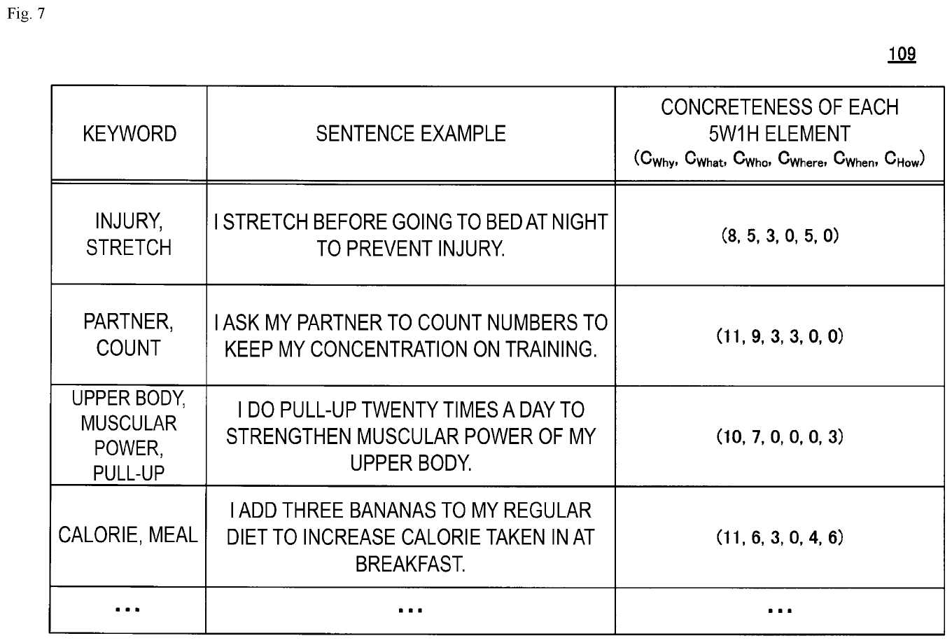

The sentence example DB 109 is a database in which one or a plurality of keywords, sentence examples corresponding to the one or plurality of keywords, and concreteness of each 5W1H element in the sentence examples are stored in an associated manner. An example of the sentence example DB 109 according to the present embodiment is illustrated in FIG. 7. FIG. 7 is a diagram illustrating an example of the sentence example DB 109 according to the present embodiment. Note that the concreteness CWhy, CWhat, CWho, CWhere, CWhen, and CHow of the 5W1H elements in each sentence example is calculated in advance by the concreteness calculation unit 105.

In the sentence example DB 109 illustrated in FIG. 7, keywords “injury” and “stretch”, and a sentence example “I stretch before going to bed at night to prevent injury.” and (CWhy, CWhat, CWho, CWhere, CWhen, CHow)=(8, 5, 3, 0, 5, 0) are stored in an associated manner. Similarly, in the sentence example DB 109 illustrated In FIG. 7, keywords “partner” and “count”, a sentence example “I ask my partner to count numbers to keep my concentration on training.”, and (CWhy, CWhat, CWho, CWhere, CWhen, CHow)=(11, 9, 3, 3, 0, 0) are stored in an associated manner. The same applies to the following.

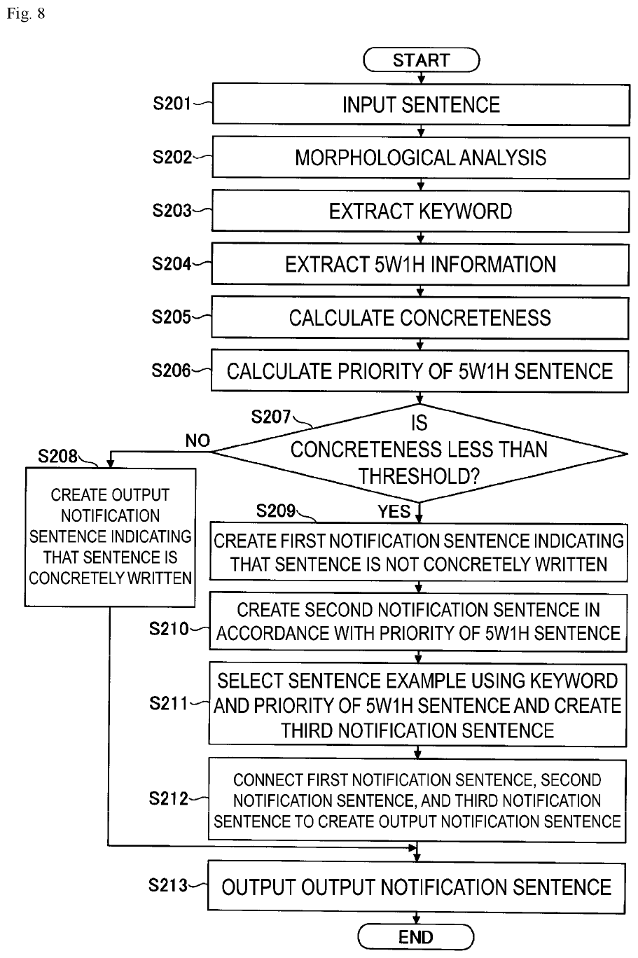

Concrete Sentence Expression Assistance Processing Next, concrete sentence expression assistance processing according to the present embodiment will be described with reference to FIG. 8. FIG. 8 is a flowchart illustrating an example of concrete sentence expression assistance processing according to the present embodiment. Note that because Steps S201 to S204 in FIG. 8 are similar to Steps S101 to S104 in FIG. 4, respectively, description thereof will be omitted.

After Step S204, the concreteness calculation unit 105 acquires keyword concreteness Km corresponding to keywords km (where m=1, M) from the keyword concreteness DB 108 and calculates concreteness C by either calculation example 1 or 2 below (Step S205).

### Calculation Example 1

As described above, 5W1H information is represented in the form of (a label representing a word or a phrase included in a sentence and which 5W1H elements the word or the phrase answers for).

Thus, a weight of an element represented by the label corresponding to the word or the phrase including the keyword km is defined as am. Specifically, in a case in which 5W1H information (“I”; Who label) and a keyword km=“I” are obtained, for example, am=aWho is defined. Similarly, in a case in which 5W1H information (“muscular power of my upper body”; What label) and a keyword km′=“upper body” are obtained, for example, am′=aWhat is defined.

Then, the concreteness calculation unit 105 calculates the concreteness C as follows.

C=a1×K1+a2×K2+ . . . +aM×KM

### Calculation Example 2

A weight of an element represented by a label included in the i-th (where i=1, . . . , L) 5W1H information is defined as ai. Specifically, in a case in which the i-th 5W1H information is (“I”; Who label), for example, ai=aWho is defined. Similarly, in a case in which i′-th 5W1H information is (“muscular power of my upper body”; What label), for example, ai′=aWhat is defined.

Then, the concreteness calculation unit 105 calculates the concreteness C as follows.

C=(K1+ . . . +KM)+(a1+ . . . +aL)

Here, L is the number of pieces of 5W1H information extracted by the 5W1H extraction unit 104.

Note that although the number N of morphemes is not taken into consideration in both the aforementioned calculation examples 1 and 2, the number N of morphemes may be taken into consideration. In other words, the concreteness C may be calculated by C=N+a1×K1+a2×K2+ . . . +aM×KM in the aforementioned calculation example 1. Similarly, the concreteness C may be calculated by C=N+(K1+ . . . +KM)+(a1+ . . . +aL) in the aforementioned calculation example 2.

Next, the 5W1H priority calculation unit 110 calculates priority PWhy, PWhat, PWho, PWhere, PWhen, and PHow of each 5W1H element in the sentence input in Step S201 (Step S205). The 5W1H priority calculation unit 110 calculates the priority PWhy, PWhat, PWho, PWhere, PWhen, and PHow in Steps 1 and 2 below, for example.

Step 1: First, the 5W1H priority calculation unit 110 calculates concreteness CWhy, CWhat, CWho, CWhere, CWhen, and CHow of each 5W1H element by the concreteness calculation unit 105.

For example, it is assumed that j ∈ {Why, What, Who, Where, When, How}, and the number of pieces of 5W1H information including a label representing the element j is defined as Lj. The total number of morphemes of all words or phrases included in these Lj pieces of 5W1H information is defined as Nj, and the total of keyword concreteness of all the keywords included in the words or the phrases is defined as ΣK. At this time, if the weight of the element j is assumed to be aj, the concreteness Cj of the element j is calculated by Cj=Nj+aj×ΣK.

Specifically, it is assumed that the sentence input in Step S201 is “I train my upper body muscles after breakfast.”. In this case, 5W1H information is (“I”; Who label), (“after breakfast”; when label), and (“my upper body muscles”; What label).

Thus, because the number of morphemes of “my upper body muscles” is four, for example, the concreteness CWhat is calculated by CWhat=4+aWhat×(K1+K2) when the keyword concreteness of “upper body” is defined as K1 and the keyword concreteness of “muscles” is defined as K2. Similarly, because the number of morphemes of “I” is two, for example, the concreteness CWho is calculated by CWho=2+aWho×K3 when the keyword concreteness of “I” is defined as K3. Concreteness of the other 5W1H elements is also similarly calculated.

Step 2: Then, the 5W1H priority calculation unit 110 calculates priority PWhy, PWhat, PWho, PWhere, PWhen, and PHow using the concreteness CWhy, CWhat, CWho, CWhere, CWhen, and CHow of each 5W1H element and the weights aWhy, aWhat, aWho, aWhere, aWhen, and aHow thereof.

For example, if it is assumed that j ∈ {Why, What, Who, Where, When, How}, the priority Pj is calculated by Pj=aj/(Cj+1). In this manner, higher priority is set as the weight of each element increases, and lower priority is set as the concreteness of the element is higher, for each element of 5W1H. This is because 5W1H elements with a larger weight is an element necessary for writing a sentence concretely, and the element with less concreteness needs more concreteness.

Specifically, in a case in which j=Why, for example, priority PWhy is calculated by PWhy=aWhy/(CWhy+1). Priority of the other 5W1H elements is also similarly calculated. Note that the reason that 1 is added to the denominator is to avoid zero division, and the value is not limited to 1, and an arbitrary value ε >0 may be added to the denominator.

Note that Step S206 above may be executed at any timing as long as Step S206 is performed after Steps S201 to S204 and before Steps S210 and S211, which will be described below.

Because following Steps S207 to S209 are similar to Steps S106 to S108 in FIG. 4, respectively, description thereof will be omitted.

After Step S209, the notification sentence creation unit 106 creates a second notification sentence using priority PWhy, PWhat, PWho, PWhere, PWhen, and PHow of each 5W1H element and a predetermined threshold (Step S210). In other words, the notification sentence creation unit 106 creates the second notification sentence in accordance with the element of 5W1H sentences corresponding to priority that is equal to or greater than the threshold from among the priority PWhy, PWhat, PWho, PWhere, PWhen, and PHow.

For example, it is assumed that three elements, namely, PWhy, PWhen, and PHow are equal to or greater than the threshold from among PWhy, PWhat, PWho, PWhere, PWhen, and PHow. This means that priority of “Why”, “When”, and “How” is high, and the notification sentence creation unit 106 thus creates a sentence such as “Please think about why, when, and how.” as a second notification sentence.

Similarly, it is assumed that two elements, namely PWho and PWhen, for example, are equal to or greater than the threshold from among PWhy, PWhat, PWho, PWhere, PWhen, and PHow. This means that priority of “Who” and “When” is high, and the notification sentence creation unit 106 thus creates a sentence such as “Please think about who and when.” as the second notification sentence.

In this manner, the second notification sentence for assisting writing of an answer to an 5W1H element with high priority is created in the present embodiment. In this manner, it is possible to encourage the user to write an answer even for 5W1H elements for which answer words or phrases are written as long as the priority thereof is high (that is, in a case in which the answer to the element of 5W1H is not sufficient, for example), unlike the first embodiment. Similarly, it is possible to prevent encouragement of writing of an answer even for an 5W1h element for which answer words or phrases are not written as long as priority thereof is low (that is, in a case in which the answers to the 5W1H elements are not important, for example) unlike the first embodiment.

Next, the notification sentence creation unit 106 creates a third notification sentence using the keywords extracted in Step S203 and priority PWhy, PWhat, PWho, PWhere, PWhen, and PHow of each element of 5W1H sentences (Step S211). At this time, the notification sentence creation unit 106 selects, from the sentence example DB 109, a sentence example with a high degree of matching with the keywords extracted in Step S203 and with higher concreteness of 5W1H elements with higher priority and creates the third notification sentence from the selected sentence example.

For example, the notification sentence creation unit 106 may select, from the sentence example DB 109, a sentence example with the highest degree of matching with the keywords extracted in Step S203 in a case in which one sentence example is determined, or may select, from the sentence example DB 109, a sentence example DB 109, a sentence example with a higher concreteness of the 5W1H elements with high priority in a case in which there are a plurality of sentence examples with the highest degree of matching.

Alternatively, the notification sentence creation unit 106 may calculate a score of each sentence example using the degree of matching with the keywords extracted in Step S203 and the priority of each 5W1H element and select the sentence example with the highest score from the sentence example DB 109, for example. It is considered that such a score is calculated as follows by defining a degree of matching between the keywords extracted in Step S203 and a sentence example Ei (i is the number for identifying the sentence example) as Ri and defining concreteness of each 5W1H element in the sentence example Ei as CWhy,i, CWhat,i, CWho,i, CWhere,i, CWhen,i, and CHow,i, for example.

Score of sentence example Ei=Ri+PWhy×CWhy,i+PWhat×CWhat,i+PWho×CHow,i+PWhere×CWhere,i+PWhen×CWhen,i+PHow×CHow,i.

However, the aforementioned method of calculating the score is one example, and it is possible to use various scores as long as it is possible to take the degree of matching with the keywords, the priority of the 5W1H elements, and the concreteness of each element of 5W1H in the sentence example into consideration with the score.

Note that the concreteness of each 5W1H element in each sentence example stored in the sentence example DB 109 is calculated in advance by the method described in Steps S202 to S204 and S206 described above and is stored in the sentence example DB 109.

Following Steps S212 and S213 are similar to Steps S112 and S113 in FIG. 4, respectively, and the description thereof will thus be omitted.

As described above, the concrete sentence expression assistance apparatus 10 according to the present embodiment determines whether the input sentence is concrete in consideration of the weight of each 5W1H element set in advance as well, calculates priority of each 5W1H element in a case in which the sentence is not concrete, and presents, to the user, information (output notification sentence) in consideration of the priority. It is thus possible to assist writing of a more concrete sentence in consideration of a domain and the like of an input sentence, for example.

The present disclosure is not limited to the above-described embodiment disclosed specifically, and various modifications or changes, combinations with known techniques, and the like can be made without departing from description of the claims.

The present application is based on a basic application PCT/JP 2020/011194 filed Mar. 13, 2020 in Japan, entire content of which is incorporated herein by reference.

### REFERENCE SIGNS LIST

10 Concrete sentence expression assistance apparatus
101 Input unit
102 Morphological analysis unit
103 Keyword extraction unit
104 5W1H extraction unit
105 Concreteness calculation unit
106 Notification sentence creation unit
107 Output unit
108 Keyword concreteness DB
109 Sentence example DB

1. An assistance apparatus comprising a processor configured to execute a method comprising:
calculating, by using a plurality of predetermined words included in an input sentence and an answer expression describing an answer to at least one 5W1H element in the input sentence, concreteness indicating a degree to which the input sentence is concretely written; and
creating a notification sentence for encouraging a user to write a concrete sentence in a case in which the concreteness is lower than a predetermined threshold.

2. The assistance apparatus according to claim 1, wherein the calculating further comprises calculating the concreteness by using at least word concreteness indicating how semantically concrete the plurality of predetermined words are and a number of answer expressions included in the input sentence.

3. The assistance apparatus according to claim 1, wherein the calculating further comprises calculating, as the concreteness, at least one of a weighting addition of word concreteness indicating how semantically concrete the plurality of predetermined words are and a weight set in advance for a 5W1H element that is answered by the answer expression including the plurality of predetermined words or a sum of the word concreteness and the weight set in advance for a 5W1H element that is answered by the answer expression included in the input sentence.

4. The assistance apparatus according to claim 3, the processor further comprises a method comprising:
calculating, by using the word concreteness of the plurality of predetermined words included in the input sentence and the weight set in advance for the 5W1H element that is answered by the answer expression included in the input sentence, a priority of each 5W1H element in the input sentence,
wherein the creating further comprises creating the notification sentence in accordance with the priority of the 5W1H element.

5. The assistance apparatus according to claim 4, the processor further configured to execute a method comprising:
calculating concreteness of each 5W1H element in the input sentence, by using the word concreteness of the plurality of predetermined words included in the input sentence and the weight set in advance for the 5W1H element that is answered by the answer expression included in the input sentence, and
calculating the priority of the 5W1H element such that the higher priority is given when the weight set for the 5W1H element is larger and a lower priority is given when the concreteness of the 5W1H element is higher.

6. The assistance apparatus according to claim 4, wherein the notification sentence creation unit creates the notification sentence including a sentence for encouraging a user to write an answer to the 5W1H element with higher priority.

7. The assistance apparatus according to claim 1, the processor further configured to execute a method comprising:
creating, as the notification sentence, a sentence including at least a first sentence indicating that the input sentence is not concrete and a second sentence that is an example sentence including the plurality of predetermined words and being concretely written.

8. An assistance method implemented by a computer, the method comprising:
calculating, by using a plurality of predetermined words included in an input sentence and an answer expression describing an answer to at least one 5W1H element in the input sentence, concreteness indicating a degree to which the input sentence is concretely written; and
creating a notification sentence for encouraging a user to write a concrete sentence in a case in which the concreteness is lower than a predetermined threshold.

9. A computer-readable non-transitory recording medium storing computer-executable program instructions that when executed by a processor cause a computer to execute a method comprising:
calculating, by using a plurality of predetermined words included in an input sentence and an answer expression describing an answer to at least one 5W1H element in the input sentence, concreteness indicating a degree to which the input sentence is concretely written; and
creating a notification sentence for encouraging a user to write a concrete sentence in a case in which the concreteness is lower than a predetermined threshold.

10. The assistance apparatus according to claim 5, wherein the notification sentence creation unit creates the notification sentence including a sentence for encouraging a user to write an answer to the 5W1H element with higher priority.

11. The assistance apparatus according to claim 2, the processor further configured to execute a method comprising:
creating, as the notification sentence, a sentence including at least a first sentence indicating that the input sentence is not concrete and a second sentence that is an example sentence including the plurality of predetermined words and being concretely written.

12. The assistance apparatus according to claim 3, the processor further configured to execute a method comprising:
creating, as the notification sentence, a sentence including at least a first sentence indicating that the input sentence is not concrete and a second sentence that is an example sentence including the plurality of predetermined words and being concretely written.

13. The assistance apparatus according to claim 4, the processor further configured to execute a method comprising:
creating, as the notification sentence, a sentence including at least a first sentence indicating that the input sentence is not concrete and a second sentence that is an example sentence including the plurality of predetermined words and being concretely written.

14. The assistance method according to claim 8, wherein the calculating further comprises calculating the concreteness by using at least word concreteness indicating how semantically concrete the plurality of predetermined words are and a number of answer expressions included in the input sentence.

15. The assistance method according to claim 8, wherein the calculating further comprises calculating, as the concreteness, at least one of a weighting addition of word concreteness indicating how semantically concrete the plurality of predetermined words are and a weight set in advance for a 5W1H element that is answered by the answer expression including the plurality of predetermined words or a sum of the word concreteness and the weight set in advance for a 5W1H element that is answered by the answer expression included in the input sentence.

16. The assistance method according to claim 15, further comprising:
calculating, by using the word concreteness of the plurality of predetermined words included in the input sentence and the weight set in advance for the 5W1H element that is answered by the answer expression included in the input sentence, a priority of each 5W1H element in the input sentence,
wherein the creating further comprises creating the notification sentence in accordance with the priority of the 5W1H element.

17. The assistance method according to claim 16, further comprising:
calculating concreteness of each 5W1H element in the input sentence, by using the word concreteness of the plurality of predetermined words included in the input sentence and the weight set in advance for the 5W1H element that is answered by the answer expression included in the input sentence, and
calculating the priority of the 5W1H element such that the higher priority is given when the weight set for the 5W1H element is larger and a lower priority is given when the concreteness of the 5W1H element is higher.

18. The computer-readable non-transitory recording medium according to claim 9, the computer-executable program instructions when executed further causing the computer to execute a method comprising:
calculating the concreteness by using at least word concreteness indicating how semantically concrete the plurality of predetermined words are and a number of answer expressions included in the input sentence.

19. The computer-readable non-transitory recording medium according to claim 9, the computer-executable program instructions when executed further causing the computer to execute a method comprising:
calculating, as the concreteness, at least one of a weighting addition of word concreteness indicating how semantically concrete the plurality of predetermined words are and a weight set in advance for a 5W1H element that is answered by the answer expression including the plurality of predetermined words or a sum of the word concreteness and the weight set in advance for a 5W1H element that is answered by the answer expression included in the input sentence.

20. The computer-readable non-transitory recording medium according to claim 19, the computer-executable program instructions when executed further causing the computer to execute a method comprising:
calculating, by using the word concreteness of the plurality of predetermined words included in the input sentence and the weight set in advance for the 5W1H element that is answered by the answer expression included in the input sentence, a priority of each 5W1H element in the input sentence,
wherein the creating further comprises creating the notification sentence in accordance with the priority of the 5W1H element.
